(19) United States
(12) Patent Application Publication
(10) Pub. No.: US 2013/0124238 A1
(43) Pub. Date: May 16, 2013

(54) Detecting Travel Information

(71) Applicants: Emma Burrows, Zurich (CH); Diana Stroe, Zurich (CH)

(72) Inventors: Emma Burrows, Zurich (CH); Diana Stroe, Zurich (CH)

(73) Assignee: GOOGLE INC., Mountain View, CA (US)

(21) Appl. No.: 13/298,278

(22) Filed: Nov. 16, 2011

(51) Int. Cl. G06Q 10/02

(52) U.S. Cl. 705/6

(57) ABSTRACT

Methods, systems, and apparatus, including computer programs encoded on a computer storage medium, for detecting travel information. In one aspect, a method includes receiving a document; annotating detected entities in the document; generating one or more travel leg structures using the annotations, wherein generating the one or more travel leg structures includes determining that one or more annotations match a valid travel schedule; and generating an itinerary from the one or more travel leg structures.

### BACKGROUND

This specification relates to detecting travel information.

Conventional online travel booking sites allow users to identify and purchase travel according to a specified itinerary. For example, a user can purchase an airline flight itinerary for a flight departing from one location on a particular date and arriving at another location. Typically, following the purchase of a particular flight itinerary, the online travel booking site sends an electronic confirmation e-mail to the user that includes the purchased itinerary.

Conventional electronic calendars allow users to schedule events with respect to particular dates and times. Typically, a user creates a calendar entry that includes at least a date of the event and optionally includes additional information, e.g., a time span or a description of the event.

### SUMMARY

This specification describes technologies relating to detecting travel information in electronic documents.

Travel information can be extracted from documents. For example, travel information can be extracted from confirmation documents, e.g., flight confirmation e-mails. The extracted travel information can be used, for example, to generate calendar entries corresponding to different legs of a travel itinerary.

A system can extract travel information from a document by generating travel leg structures using entity annotations extracted from the document. Generating each travel leg structure includes determining if annotations match a valid travel schedule and identifying closest occurring departure and arrival time annotations that match the schedule to generate a travel leg core. Additional annotations near each travel leg core are identified to generate a travel leg span. The system can identify a coherent itinerary using the one or more travel leg spans.

In general, one innovative aspect of the subject matter described in this specification can be embodied in methods that include the actions of receiving a document; annotating detected entities in the document; generating one or more travel leg structures using the annotations, wherein generating the one or more travel leg structures includes determining that one or more annotations match a valid travel schedule; and generating an itinerary from the one or more travel leg structures. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. The method further includes generating one or more calendar entries from the itinerary. The method further includes adding a calendar entry of the one or more calendar entries to an electronic calendar in response to a user input. Generating a travel leg structure of the one or more travel leg structures includes: determining an annotated entity that matches the travel schedule; determining a leg core using a closet departure and arrival annotations that match the schedule; and determining a leg span using one or more other annotations closest to the leg core. The method further includes, for each travel leg structure, determining one or more potential departure dates. Generating an itinerary includes determining the one or more potential departure dates such that each travel leg occurs in chronological order. The method further includes performing a recursive process to determine all possible sequences of departure and arrival dates for the one or more travel legs. Generating the itinerary from the one or more travel leg structures comprises selecting departure and arrival dates for each leg to form a coherent itinerary. Selecting departure and arrival dates includes scoring possible departure and arrival dates according to one or more preferences. Matching one or more annotations to the travel schedule includes matching one or more of a departure time, an arrival time, a departure airport, an arrival airport, a flight number, or a departure date to the travel schedule.

Particular embodiments of the subject matter described in this specification can be implemented so as to realize one or more of the following advantages. The system can automatically create calendar entries from confirmation documents. A user does not need to individually enter each travel leg into a calendar. The system can validate travel data using travel schedule information reducing false identification of travel legs. The system can detect multiple travel legs within a single document.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is flow diagram of an example method for detecting travel information.

FIG. 2 is an example confirmation message from which travel information can be detected.

FIG. 3 is a flow diagram of an example method for determining one or more travel legs.

FIG. 4 is a flow diagram of an example method for building an itinerary from one or more travel legs.

FIG. 5 is an example calendar entry generated from detected travel information.

Like reference numbers and designations in the various drawings indicate like elements.

### DETAILED DESCRIPTION

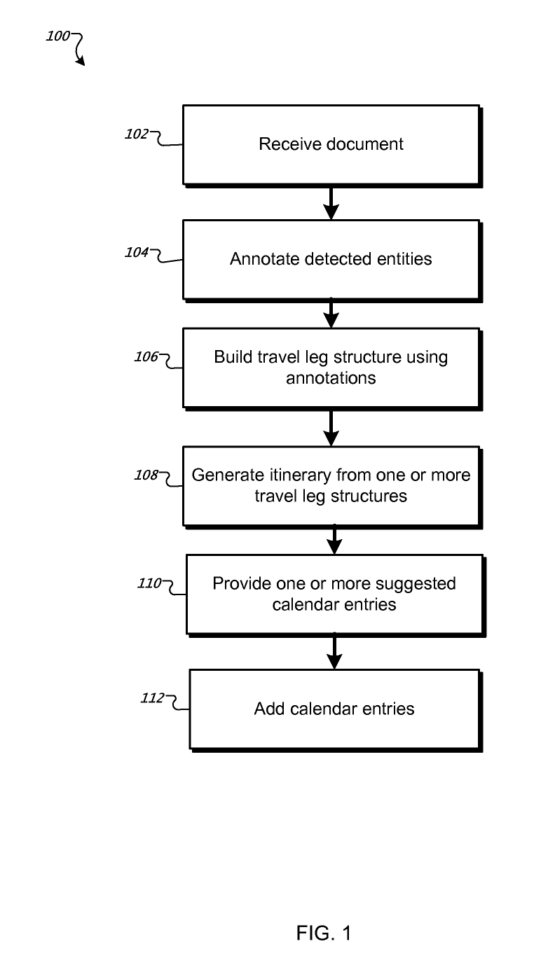

FIG. 1 is flow diagram of an example method 100 for detecting travel information. For convenience, the method 100 will be described with respect to a system, including one or more computing devices, that performs the method 100.

The system receives a document (step 102). In some implementations, the document is an e-mail document and is received through a user's e-mail account. In some other implementations, the document is an attachment to a received e-mail document. The system can be incorporated within an electronic mail system that receives e-mail messages. For example, the document can be a confirmation e-mail received in response to user activity booking one or more travel itineraries. In some implementations, a user can opt-in or opt-out of the system of detecting travel information from received e-mail documents.

In some alternative implementations, the document is received from a user, for example, by submitting the document to the system. For example, the user can submit the document to a travel management system or a calendaring system in order to generate corresponding calendar entries for travel legs on a travel itinerary.

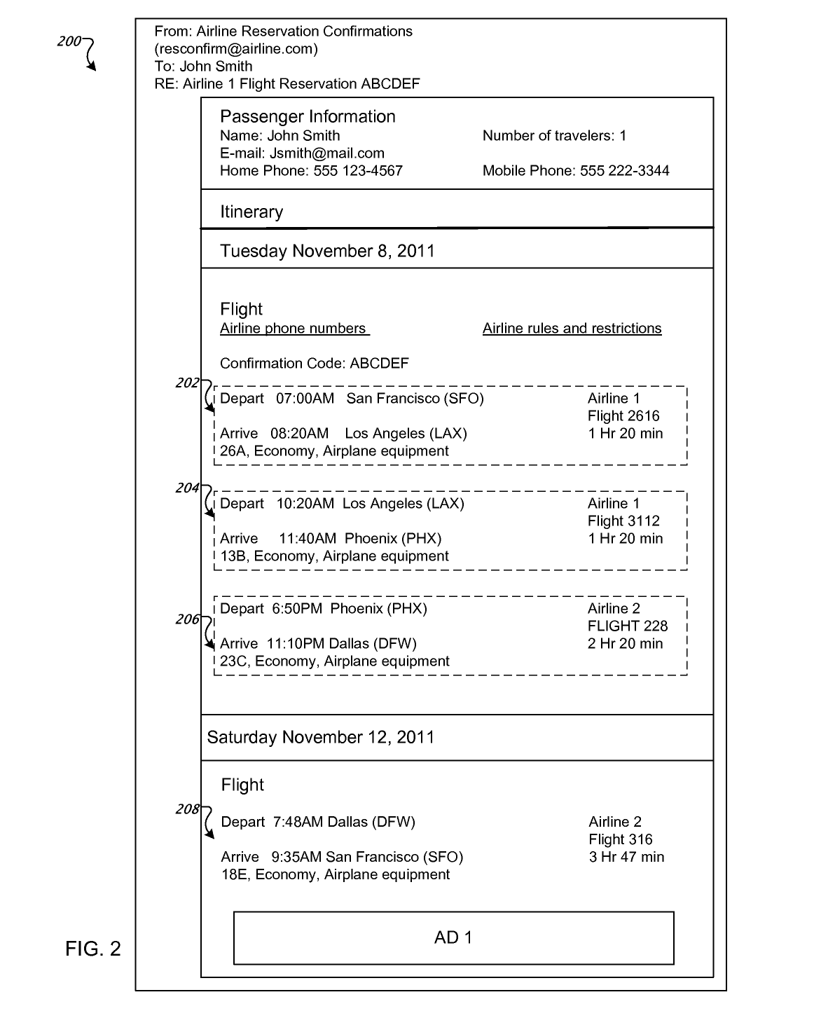

FIG. 2 is an example confirmation message from which travel information can be detected. In particular, FIG. 2 shows an e-mail confirmation 200 confirming a flight reservation. The e-mail confirmation 200 includes a description of a travel itinerary including three flight legs 202, 204, and 206 occurring on a first day and a flight leg 208 occurring on a second day.

A flight leg is a routing between an origin and a destination city. For example, leg 202 is a flight from an origin of San Francisco to Los Angeles. Similarly, leg 204 is a flight from Los Angeles to Phoenix. Although not shown, each leg can include multiple segments. A segment is a specific nonstop flight. For example, if a leg from San Francisco to New York has a connection in Chicago, the flight leg from San Francisco to Chicago has two segments, San Francisco to Chicago and Chicago to New York.

The legs 202, 204, 206, and 208 are presented in chronological order. Each flight leg 202, 204, 206, and 208 includes details about that particular leg including departure and arrival times, origin and destination airports, flight number, airline name, seat location, seating class, and the type of airplane equipment.

As shown in FIG. 1, the system annotates detected entities in the received document (step 104). An entity refers to a sequence of characters that forms a text representation of a component of a flight schedule. In particular, extraction techniques are used to identify particular types of entities relevant to a travel itinerary. For example, for a flight itinerary, the types of entities can include dates, times, cities, airport codes, flight numbers, and airline names. In particular, these entities typically compose a description of a flight leg. A flight leg corresponds to a journey from a given origin location to a given destination location, at specified times, on a specified date, associated with a given flight number, as sold by an airline.

While a flight itinerary will be referenced throughout this specification for convenience, other types of travel itineraries can be used for example, train, subway, boat, or ferry itineraries. For example, the extraction techniques can be used on a train itinerary to identify types of entities relevant to the train itinerary, including, dates, cities, and train numbers.

The extraction techniques can identify particular types of text patterns or predefined entries within the document text. Different extraction techniques can be associated with particular types of entities. For example, one extraction technique can match specific text patterns based on regular expressions. For example, flight number recognition can be based on the pattern [A-Z] {2} [0-9] {1-4}, meaning two letters followed by 1-4 digits, which corresponds to a two letter airline code followed by a 1-4 digit flight number (e.g., AB 1439 for AB airlines flight number 1439).

Another example extraction technique can search the text to identify matches out of a collection of predefined terms. For example, a dataset can include a collection of known airline names, airport codes (e.g., SFO for San Francisco International Airport), and city names. The entries in the document can be compared to entries in one or more datasets to identify a match.

The detected entities are used to construct a representation that stores corresponding annotations demarcating the relative position of each entity in the document, the type of entity, original document text matched to the entity, and a canonical representation of the entity. In particular, the representation stores the positions in the annotations that correctly represent the order and relative distance between the entities in the document.

In some implementations, the position is represented by a begin/end pair, which can refer, for example, to a position of a first character of the annotation and a last character of the annotation, respectively, in a string of characters forming the document text. For example, a begin/end pair “37/39” can refer to the beginning and end position of the annotation “SFO” for an airport type annotation, where the first character of the annotation appears at position 37 in the document and the last character of the annotation appears at position 39 in the document.

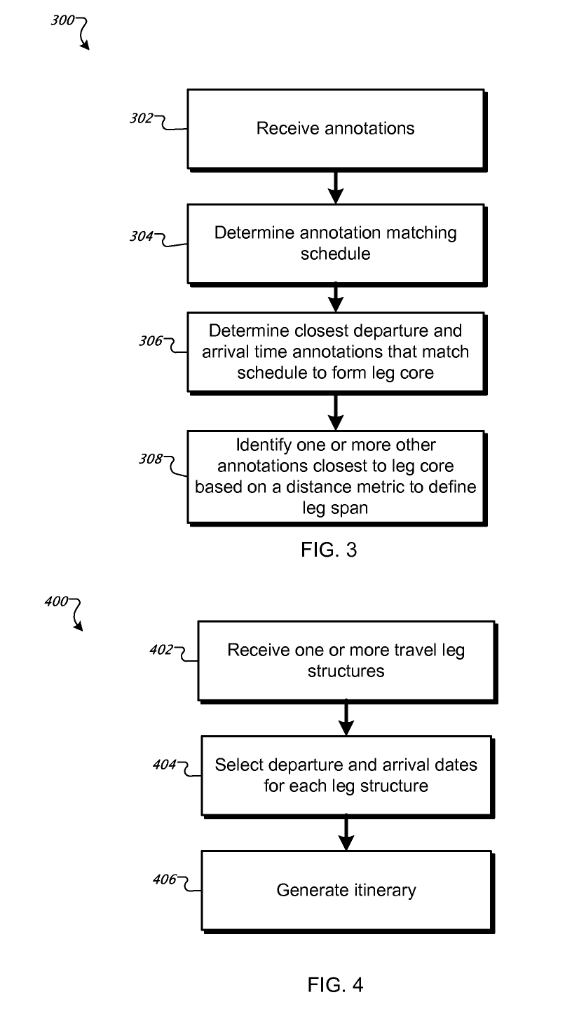

The system generates one or more travel leg structures using the annotated representation (step 104). In particular, the identified annotations from the document can be used to generate a distinct structure that represents the relative order and position of each identified annotation. Each travel leg structure includes parameters defining a particular journey. For example, a flight leg corresponds to a journey from a given origin location to a given destination location, at specified times, on a specified date, associated with a given flight number, as sold by an airline. A representation of a flight leg can be constructed from a schedule and a group of entities extracted from the document. An example of generating a travel leg structure for a flight leg is described in greater detail with respect to FIG. 3.

FIG. 3 is a flow diagram of an example method 300 for determining one or more travel legs. For convenience, the method 300 will be described with respect to a system, including one or more computing devices, that performs the method 300.

The system receives a collection of annotations from a document (step 302). The collection of annotations can be part of a representation constructed from extracted entities as described above with respect to FIG. 1.

The system determines annotations matching a travel schedule (step 304). In particular, the system uses a travel schedule to determine whether one or more annotations identifying a travel identifier match the travel schedule. The travel schedules can include flight schedules identifying various flights as well as train or bus/subway schedules. In some implementations, the travel schedule is a valid travel schedule. A valid travel schedule is one that has been determined to include reliable schedule information. This determination can be based, for example, on the source of the travel schedule. For example, a travel schedule received from the travel provided can be considered reliable. Similarly, a travel schedule received from particular aggregation services can be considered reliable. In some other implementations, the age of the travel schedule can be used to determine the reliability of the schedule information. For example, travel schedules received within a specified time period can be considered reliable.

The travel schedules can be received directly from respective travel providers, for example, from individual airlines. In some other implementations, the travel schedules can be received from one or more travel aggregators that obtain travel schedules for multiple travel providers, e.g., for a collection of airlines.

For example, the schedule for a particular flight (e.g., identified by a flight number and airline code) includes an origin, a destination, arrival and departure times, and a set of dates on which the flight operates. A given flight identifier (e.g., flight number AB 1439) can be associated with different days of the week that the flight operates. Additionally, in some instances, it is possible for the same flight number to fly between multiple origin-destination pairs, or to fly at different times on different days. It is also possible for the same flight number to be associated to a sequence of connecting flight legs. Since it is possible for multiple different legs on the same trip to have the same flight number, the system attempts to construct a leg from a schedule involving a single pair of airports and pair of times.

The system searches, for all combination of airlines and flight numbers, for a matching schedule in the annotations. In particular, the system can initialize a new flight leg and add to the flight leg all annotated entities that match an item of a particular schedule. For example, a time annotation can correspond to the schedule for a flight if the corresponding time is equal to a departure or arrival time of the flight according to the schedule.

In some implementations, if insufficient entity matches are found, the candidate leg is discarded. This is because there is insufficient confidence that the extracted entities actually correspond to a travel leg. In some implementations, in order to establish a schedule match, the system identifies matching annotations for all the entities that identify a flight leg: departure time, arrival time, departure airport, arrival airport, flight number, and departure date. When sufficient entity matches are found, the system proceeds to identify a “leg core” and a “leg span.”

The system determines closet departure and arrival time annotations that match the schedule to form the leg core (step 306). For example, a flight schedule includes departure and arrival times for each flight. The system determines annotations that correspond to departure and arrival times in the schedule. Specifically, the representation of a flight as a set of matching annotations is built around a leg core structure. The leg core is formed by the departure and arrival time annotations. In particular, the system selects, from the sets of departure and arrival time annotations that match the schedule, the two that are closest to each other as forming the leg core.

The system identifies one or more other annotations closest to the leg core to define the leg span (step 308). An assumption can be made that other entities which identify the flight leg are presented to a user as close as possible to the leg core. Additionally, when multiple legs are described in a piece of text, the respective leg cores do not overlap. Thus, the text specifies a sequence of departure-time/arrival-time in chronological order, corresponding to the legs of the trip.

A group of identifying entities (e.g., airports, times, flight number) can be used to form the “span” of the leg. The airline name, if matched, may also be included in the span, although the airline name is often not identified in each leg, especially if all the legs are on the same airline. The departure date is deliberately not included in the span. This is because the system may only be able to select departure dates accurately using an entire sequence of flight legs. In addition, the departure date is frequently specified only once in the document for multiple legs that occur on the same date.

For each of departure city or airport, arrival city or airport, flight number, and airline, the system selects a closest annotation to the leg core, based on a distance metric and increases the leg span if necessary to include it.

In some implementations, the distance metric of an annotation to the leg core is 0 if the annotation is within leg core (between the two time annotations), and the positive distance to closest end of core otherwise. In particular, the distance can represent the number of characters between a position associated with the annotation and a position of the leg core. For example, for an annotation that occurs in the text before the leg core, the distance can be a number of characters from the last character position identified by the annotation and the first character position identified for the leg core. Other positions in the annotation and leg core can be used to define the distance.

To select a departure date for the flight leg the system processes all matching date annotations and then builds representations for potential departure dates. This can be done separately for each flight leg. The system then determines a valid selection of departure dates for each leg, using all of the identified flight legs, such that they form a coherent itinerary. In particular, a coherent itinerary can be one in which the flight legs occur in non-overlapping chronological order. A coherent itinerary can further be an itinerary that removes duplicates, e.g., codeshare flights.

For each date annotation that matches a departure date on the travel schedule, the system searches for a closest matching potential arrival date. A departure date-arrival date pair matches the travel schedule if the arrival date annotation is after the departure date annotation in the document and the departure date (plus any scheduled extra day, e.g., for overnight flights) is equal to the arrival date. In some implementations, an arrival date is only used if it within a specified distance threshold to the leg core, for example where the specified distance threshold is equal to twice the length of the leg span. If no arrival date match is found, the arrival date can be inferred based on the schedule of the flight leg. The system constructs a departure date structure from each departure date-arrival date pair and calculates a distance and position of the departure date-arrival date pair with respect to the leg core. The system generates a list of all potential departure dates and sorts the list by distance to the leg core.

As shown in FIG. 1, the system generates an itinerary from the one or more travel leg structures (step 106). The document is assumed to be human-readable text, and therefore it can be assumed that the legs of an itinerary will be presented in chronological order, with minimum if any overlap between individual legs. Therefore, the system sorts the legs by their position in the document and attempts to remove any legs that overlap each other or are duplicates (e.g. codeshare flight numbers). An example of generating an itinerary is described below with respect to FIG. 4.

FIG. 4 is a flow diagram of an example method 400 for building an itinerary from one or more travel legs. For convenience, the method 400 will be described with respect to a system, including one or more computing devices, that performs the method 400.

The system receives one or more travel leg structures (step 402). The travel leg structures can be generated, for example, as described above with respect to FIG. 3.

Using the travel leg structures, the system attempts to select departure and arrival dates for each leg (step 404). The departure and arrival dates for each leg can be selected such that a sequence of legs forms a coherent itinerary, in particular, an itinerary having legs that occur in chronological order (e.g., such that a first arrival date occurs prior to a next departure date). Additionally, the system uses text formatting information from the document to select a most likely set of dates. Specifically, a selection of departure dates can be determined to be valid only if all dates are in the same position versus their respective legs, have the same format, and cause the legs to be in chronological order.

To construct all possible date selections, the system can use a recursive function that uses the following parameters:

“i”—the index of the leg, i>0

“legs”—the whole set of legs.

“selection”—a partial selection including dates for legs 0 to i−1

“output”—a vector to add complete selections to.

For each possible date for leg “i”, the a recursive process adds the date to a partial selection if the selection remains valid for the date, and the recursive process repeats for leg i+1. If i==legs.size( ), the recursive process adds the complete selection to “output”. Thus, the recursive process constructs all possible date selections for each leg. In particular, the process is repeated for each leg, but using a different partial selection resulting in different sets of date selection. For each partial selection some, all, or none of the dates of the current leg may be used to construct further valid date selections. If none of the dates can be used, then there is no valid date selection that starts with this partial selection. For each partial selection, a different subset of dates for the current leg may be usable.

In particular, the recursive process can be performed as follows:

Initially, assume the recursive process has a date for leg 0 in the partial selection.
call BuildDateSelection(1, legs, {D0_i}, output)
for each date D1_j of leg 1 that is {chronologically after D0_i, and in the same text format, and in the same position versus its leg}
   add Date D1_j to the partial selection and call BuildDateSelection(2, legs, {D0_i, D1_j}, output) to build all date selections in which leg 0 is on date Do_i and leg 1 is on date D1_j.
   call BuildDateSelection(1, legs, {D0_i, D1_j}, output)
   for each date D2_k of leg 2, that is {chronologically after D1_j, and in the same text format, and in the same position versus its leg}
      add D2_k to the partial selection and call the recursive method for leg 3.
         call BuildDateSelection(n, legs, {D0_i, D1_j, D2_k, . . . Dn-1_p, output)
         n==number of legs
         the partial selection now contains a date for each leg, and we know this selection is valid
         add the partial selection to the output and return
      call BuildDateSelection(n−1, legs, {D0_i, D1_j, D2_k, . . . }, output)
      pick the next plausible date for leg n and call BuildDateSelection(n, legs, {D0_i, D1_j, D2_k, . . . Dn_q}, output)
   this call adds the selection to the output
   when the system has gone through all possible dates for leg n
   remove the date for leg n from the selection
return to BuildDateSelection(1, legs, {D0_i, D1_j}, output)
pick the next plausible date for leg 2 and call the method again for leg 3
repeat until there are no more dates for leg 1.

The recursive process starts over for the next date of leg 0. When the recursive process has completed for all the dates of leg 0, the system has constructed all possible valid sequences of dates.

BuildDateSelection can be called many times for each leg, but each time it is called with a different partial selection, therefore it will generate a different set of date selections. For each partial selection 0 to k−1, some, or all, or none of the dates of the current leg k may be used to construct further valid date selections. If none of the dates can be used, then there is no valid date selection that starts with this partial selection. For each partial selection 0 to k−1, a different subset of dates for the current leg k may be usable.

In some implementations, the recursive loops are limited by dropping dates that are too far from the leg according to some formula.

Often multiple date selections are possible for the one or more travel legs. As a result, the system further scores each of the possible date selections using a date selection score. The system can apply a highest preference (e.g., resulting in a higher score) to date selections in which all dates are closer to their respective legs' cores. For equal distance scores, selections where more departure dates have explicit arrival dates in the text can be preferred.

If all these are equal, date selections usually involve ambiguous dates with multiple interpretations (e.g. 09.01.2010). The system applies a preference (e.g., higher score) to dates that are more “likely” based on a priority assigned by the date extractor.

In some implementations, an arrival date score is similarly generated. For example, the arrival date score can be used for the following pattern:

“date1 time1 date2 time2” such as “02-17 10:00 PM 02-18 06:00 AM”

In some implementations, the pattern can results in two possible selections:

Selection 1: 02-17→02-18 with distance 0 (02-18 is within the core)

Selection 2: 02-18→02-19 with distance 0 (02-18 is within the core)

The highest scoring date selection can be applied to the legs. For example, between two selections in which dates are equally close to their respective flight legs (equal distance scores) the system can prefer the selection in which more of the departure dates explicitly specify arrival dates in the document text. In the above example, “selection 1” has an arrival date 02-18 explicitly mentioned, but “selection 2” does not. The system infers the arrival date 02-19 assuming that 02-18 is the departure date based on knowing that this flight is overnight and arrives the next day. Consequently, “selection 1” is preferred and scored higher than “selection 2.”

The system generates an itinerary (step 406). In particular, the system generates an itinerary if date selections are identified for the one or more travel legs. The system generates the itinerary from the sequence of flight legs having the date selections. The generated itinerary can be used to create calendar entries, as described below.

As shown in FIG. 1, the system provides one or more suggested calendar entries based on the generated itinerary (step 110). For example, the system can populate fields of a calendar entry and present the suggested calendar entry to the user within a user interface. In some implementations, the system includes both mail and calendar services. After receiving an e-mail document and generating the itinerary, the system can suggest calendar entries for the calendar service within the mail interface.

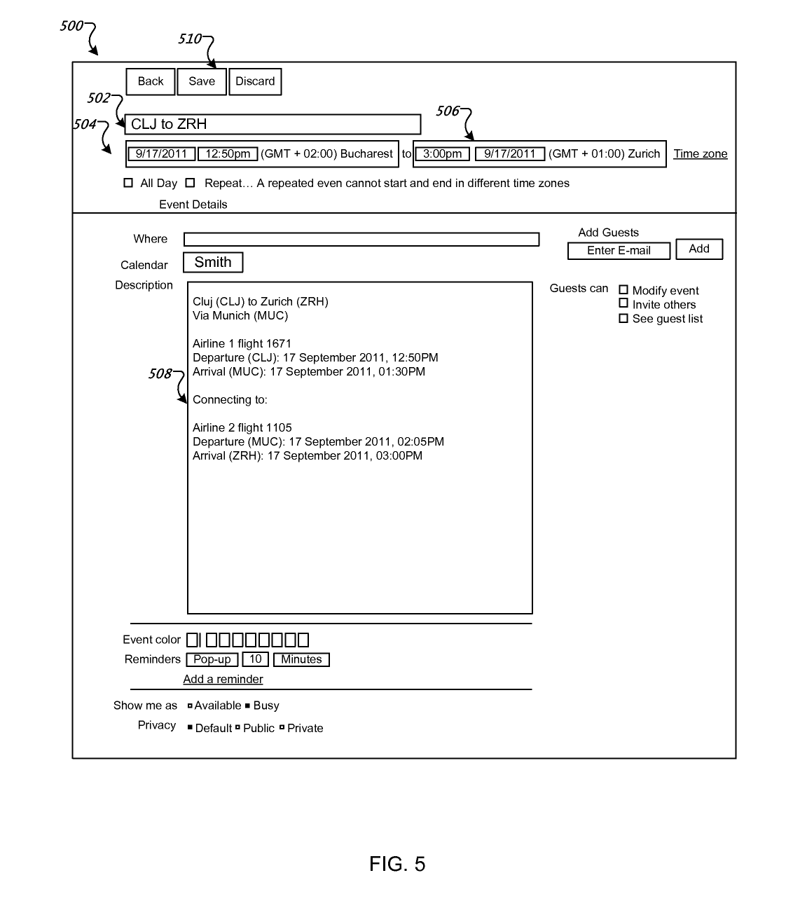

In some implementations, each calendar entry for leg is presented serially to the user. In some other implementations, calendar entries for each leg can be presented contemporaneously within the interface. An example suggested calendar entry is described below with respect to FIG. 5.

The system adds user designated calendar entries to a calendar (step 112). Designated calendar entries can be those suggested calendar entries accepted by the user. Once added to the calendar, the respective designated calendar entries are stored and can be later modified by the user. Additionally, in some implementations, the calendar entries include one or more default reminders or reminders as specified by a user.

FIG. 5 is an example calendar entry 500 generated from detected travel information. In particular, the example calendar entry 500 is for a particular flight leg. The calendar entry 500 can be suggested to the user for a particular leg of one or more legs in an itinerary generated from a document (e.g., from a travel confirmation document). The calendar entry 500 includes a number of fields that have been prepopulated from flight leg information. Thus, the prepopulated fields are derived from leg information extracted from the document.

The prepopulated fields include a title 502, departure information 504, arrival information 506, and a description 508. The title 502 is populated to indicate the flight origin and destination. In particular, the title 502 indicates the flight leg from “CLJ to ZRH” indicating that the leg is from an origin airport of Cluj, Romania to a destination airport of Zurich, Switzerland.

The departure information 504 includes the departure date and time, in this example departing Sep. 17, 2011 at 12:50 pm local time. Similarly, the arrival information 506 includes the arrival date and time, in this example arriving at 3:00 pm local time on Sep. 17, 2011. The description 508 includes text describing the flight leg including the airline and flight numbers as well as connecting flight segment information for the leg. In some implementations, the text in the description 508 is extracted from the document text. In some other implementations, the text in the description 508 is generated from the extracted entities.

The user can save the calendar entry to a calendar, for example, by selecting the “save” button 510. Additionally, the user can modify the entries or other fields. For example, the user can add additional descriptive text to the description 508 as well as change other calendar parameters associated, for example, how the calendar entry is displayed in the calendar (e.g., color) and establishing reminders.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
receiving a document;
annotating detected entities in the document;
generating one or more travel leg structures using the annotations, wherein generating the one or more travel leg structures includes determining that one or more annotations match a valid travel schedule; and
generating an itinerary from the one or more travel leg structures.

2. The method of claim 1, further comprising:
generating one or more calendar entries from the itinerary.

3. The method of claim 2, further comprising:
adding a calendar entry of the one or more calendar entries to an electronic calendar in response to a user input.

4. The method of claim 1, wherein generating a travel leg structure of the one or more travel leg structures comprises:
determining an annotated entity that matches the travel schedule;
determining a leg core using a closet departure and arrival annotations that match the schedule; and
determining a leg span using one or more other annotations closest to the leg core.

5. The method of claim 4, further comprising, for each travel leg structure, determining one or more potential departure dates.

6. The method of claim 5, wherein generating an itinerary includes determining the one or more potential departure dates such that each travel leg occurs in chronological order.

7. The method of claim 6, further comprising performing a recursive process to determine all possible sequences of departure and arrival dates for the one or more travel legs.

8. The method of claim 1, wherein generating the itinerary from the one or more travel leg structures comprises selecting departure and arrival dates for each leg to form a coherent itinerary.

9. The method of claim 8, where selecting departure and arrival dates includes scoring possible departure and arrival dates according to one or more preferences.

10. The method of claim 1, wherein matching one or more annotations to the travel schedule includes matching one or more of a departure time, an arrival time, a departure airport, an arrival airport, a flight number, or a departure date to the travel schedule.

11. A system comprising:
one or more computers configured to perform operations comprising:
receiving a document;
annotating detected entities in the document;
generating one or more travel leg structures using the annotations, wherein generating the one or more travel leg structures includes determining that one or more annotations match a valid travel schedule; and
generating an itinerary from the one or more travel leg structures.

12. The system of claim 11, further configured to perform operations comprising:
generating one or more calendar entries from the itinerary.

13. The system of claim 12, further configured to perform operations comprising:
adding a calendar entry of the one or more calendar entries to an electronic calendar in response to a user input.

14. The system of claim 11, wherein generating a travel leg structure of the one or more travel leg structures comprises:
determining an annotated entity that matches the travel schedule;
determining a leg core using a closet departure and arrival annotations that match the schedule; and
determining a leg span using one or more other annotations closest to the leg core.

15. The system of claim 14, further configured to perform operations comprising, for each travel leg structure, determining one or more potential departure dates.

16. The system of claim 15, wherein generating an itinerary includes determining the one or more potential departure dates such that each travel leg occurs in chronological order.

17. The system of claim 16, further configured to perform operations comprising performing a recursive process to determine all possible sequences of departure and arrival dates for the one or more travel legs.

18. The system of claim 11, wherein generating the itinerary from the one or more travel leg structures comprises selecting departure and arrival dates for each leg to form a coherent itinerary.

19. The system of claim 18, where selecting departure and arrival dates includes scoring possible departure and arrival dates according to one or more preferences.

20. The system of claim 11, wherein matching one or more annotations to the travel schedule includes matching one or more of a departure time, an arrival time, a departure airport, an arrival airport, a flight number, or a departure date to the travel schedule.

21. A computer storage medium encoded with a computer program, the program comprising instructions that when executed by one or more computers cause the one or more computers to perform operations comprising:
receiving a document;
annotating detected entities in the document;
generating one or more travel leg structures using the annotations, wherein generating the one or more travel leg structures includes determining that one or more annotations match a valid travel schedule; and
generating an itinerary from the one or more travel leg structures.

22. The computer storage medium of claim 21, further comprising instructions that when executed by one or more computers cause the one or more computers to perform operations comprising:
generating one or more calendar entries from the itinerary.

23. The computer storage medium of claim 22, further comprising instructions that when executed by one or more computers cause the one or more computers to perform operations comprising:
adding a calendar entry of the one or more calendar entries to an electronic calendar in response to a user input.

24. The computer storage medium of claim 21, wherein generating a travel leg structure of the one or more travel leg structures comprises:
determining an annotated entity that matches the travel schedule;
determining a leg core using a closet departure and arrival annotations that match the schedule; and
determining a leg span using one or more other annotations closest to the leg core.

25. The computer storage medium of claim 24, further comprising instructions that when executed by one or more computers cause the one or more computers to perform operations comprising, for each travel leg structure, determining one or more potential departure dates.

26. The computer storage medium of claim 25, wherein generating an itinerary includes determining the one or more potential departure dates such that each travel leg occurs in chronological order.

27. The computer storage medium of claim 26, further comprising instructions that when executed by one or more computers cause the one or more computers to perform operations comprising performing a recursive process to determine all possible sequences of departure and arrival dates for the one or more travel legs.

28. The computer storage medium of claim 21, wherein generating the itinerary from the one or more travel leg structures comprises selecting departure and arrival dates for each leg to form a coherent itinerary.

29. The computer storage medium of claim 28, where selecting departure and arrival dates includes scoring possible departure and arrival dates according to one or more preferences.

30. The computer storage medium of claim 21, wherein matching one or more annotations to the travel schedule includes matching one or more of a departure time, an arrival time, a departure airport, an arrival airport, a flight number, or a departure date to the travel schedule.
